(19) United States
(12) Patent Application Publication
(10) Pub. No.: US 2014/0030418 A1
(43) Pub. Date: Jan. 30, 2014

(54) SET OF MODULAR BEVERAGE PREPARATION MACHINES AND PROCESSES FOR CONFIGURING AND MANUFACTURING THE MACHINES

(71) Applicants: Alexis Reust, Lausanne (CH); Richard Luke Murphy, Chagrin Falls, OH (US); Yann Brunner, Nuvilly (CH)

(72) Inventors: Alexis Reust, Lausanne (CH); Richard Luke Murphy, Chagrin Falls, OH (US); Yann Brunner, Nuvilly (CH)

(73) Assignee: NESTEC S.A., VEVEY (CH)

(21) Appl. No.: 14/110,294

(22) PCT Filed: Apr. 3, 2012
(86) PCT No.: PCT/EP12/56045

§ 371 Date: Oct. 7, 2013

(30) Foreign Application Priority Data
Apr. 5, 2011 (EP) 11161213.1

(51) Int. Cl. A47J 31/44

(52) U.S. Cl. CPC A47J 31/4403
USPC 426/590; 99/289 R; 29/428

(57) ABSTRACT

The invention concerns a set of differing beverage production machines, the machines comprising: —one core unit comprising at least a diluent supply system, and —one food ingredient storing module, said storing module being selected in a plurality of different alternative modules for storing the food ingredient, and/or —one food ingredient dosing module, said dosing module being selected in a plurality of different alternative modules for dosing the food ingredient, and/or —one food ingredient processing module, said processing module being selected in a plurality of different alternative modules for processing the food ingredient.

### FIELD OF THE INVENTION

The present invention relates to a set of differing beverage production machines, the machines comprising a core unit and variable modules for storing, dosing and/or processing food ingredients.

### BACKGROUND OF THE INVENTION

The manufacturing of beverage preparation machines offering different beverage delivery capacities is complex and costly. There is a need for rationalizing the manufacture of the beverage machines while still providing a large range of machines with different options for the operator.

U.S. Pat. No. 5,957,033 describes a coffee machine that can be rapidly assembled. The machine is composed of several modules that are disposed such that they can be slid in a frame. These modules are a roasted and ground coffee powder extraction device, a water supply and an electronic control. The proposed process of manufacturing is simplified but only one type of machine is manufactured.

EP 2 070 454 describes the modular manufacturing of beverage production machines. All the machines present an identical core unit comprising a control circuitry and a beverage production module that is designed for frame a sealed capsule or a pod comprising a food ingredient and feeding a liquid to the interior of the capsule or pod. The machine also comprises a platform for mounting the core unit. The modularity consists in manufacturing different platforms on which different numbers of identical core units can be mounted. This process enables the production of a set of machines that differ by the number of units for processing the sealed capsule or the pod. It doesn't enable the manufacture of machines differing by the manner the food ingredient is packaged and/or the food ingredient is processed.

Yet it would be an advantage to propose a range of beverage preparation machines proposing the preparation of several various different beverages (not only coffee but also tea, milk, chocolate and mixtures thereof), different types of food ingredient packaging for feeding the machines, different qualities of beverage preparation and consequently presenting different level of costs depending of the requirement of the operator for his customers while simplifying the manufacturing of these different machines. It would then be possible to propose to the operators a large choice of differing beverage preparation machines adapted to each type of consumption (depending from e.g. the place where the machine is placed, the consumers who will use it) while optimizing manufacturing costs.

One aim of the present invention is to solve this problem.

### SUMMARY OF THE INVENTION

According to a first aspect, the invention concerns a set of differing beverage production machines, the machines comprising:

one core unit comprising at least a diluent supply system, and

one food ingredient storing module, said storing module being selected in a plurality of different alternative modules for storing the food ingredient, and/or

one food ingredient dosing module, said dosing module being selected in a plurality of different alternative modules for dosing the food ingredient, and/or

one food ingredient processing module, said processing module being selected in a plurality of different alternative modules for processing the food ingredient.

The beverage production machines of the present invention produce beverages by interaction between a food ingredient and a diluent. The food ingredient can be a soluble food ingredient concentrate like a soluble powder or a liquid concentrate or it can be an infusable food ingredient like a roast and ground coffee powder or tea leaves. The diluent can either dissolve the soluble food ingredient concentrate or extract the infusable food ingredient. It is usually water.

In the set of differing beverage production machines of the present invention, all the machines of a same set present a common core unit which comprises at least the system for supplying the diluent. The system for supplying the diluent usually comprises at least a heating device, a pumping device and a valve device. It can also comprise a container for storing the diluent, like a tank. The common core unit also generally comprises at last a part of the frame of the machine. According to the preferred embodiment of the invention the core unit elements common to the differing beverage production machines is also provided with a dispensing area. This area is configured for enabling the consumer to place a cup in said area for receiving the prepared beverage. Preferably the core unit common elements to the differing beverage production machines also comprise the electronic control unit of the beverage preparation machine.

The beverage production machines of the set of the present invention can differ one from the other at least by one module configured for handling the food ingredient, said module being selected in a plurality of different alternative modules for implementing the same food ingredient handling step. The food ingredient handling step can relates to the storing of the food ingredient, to the dosing of the food ingredient or to the processing of the food ingredient. The machines can differ:

by their storing module, the module being selected in a plurality of different alternative modules for storing the food ingredient, and/or

by their dosing module, said dosing module being selected in a plurality of different alternative modules for dosing the food ingredient, and/or

by their processing module, said processing module being selected in a plurality of different alternative modules for processing the food ingredient.

The present invention can cover sets of differing beverage production machines comprising only a small number of machines in one set. Actually, the machines of the set of differing beverage production machines can differ only by one type of food ingredient handling module, the other modules of the machines being identical. For example the machines of the same set can differ only by their storing module or only by their dosing module or only by their processing module.

The present invention can also cover sets of differing beverage production machines comprising a high number of machines in one set. Actually, the machines of the set of differing beverage production machines can differ by at least two types of food ingredient handling modules, each module being selected in a plurality of different alternative modules for implementing the same said food ingredient handling step. For example the machines of the same set can differ by their storing module and their dosing module and their processing module.

Preferably the machines of the set comprise one food ingredient processing module, said processing module comprising one device for contacting the food ingredient with the diluent and said processing module being selected in a plurality of different alternative modules for processing the food ingredient, the different alternative modules differing by the devices for contacting the food ingredient with the diluent. The device for contacting the food ingredient with the diluent can be comprised in the list of: a jet(s) head, a mixing bowl, a whipper bowl, a brewing chamber.

The jet(s) head can be a nozzle delivering at least one jet of diluent. Preferably it delivers at least two jets of diluent and even more preferably the jets head is able to rotate during the delivery of the diluent through the nozzle.

The mixing bowl can be a chamber configured to receive the diluent and a soluble food ingredient. It can be designed so as to make an efficient contact of the food ingredient and the diluent and improve the dissolution of a soluble food ingredient. The whipper bowl usually comprises a first part which is a mixing chamber configured to receive the diluent and a soluble food ingredient and a second part comprising a whipper configured to make the mixture of the diluent and the food ingredient foam.

The brewing chamber can be a chamber configured to receive an infusable food ingredient and water. In the brewing process, the heated water infuses and extracts flavours from the brewing substance. The brewing chamber can contain a filter to allow beverage to drain from the infused food ingredient and water mixture It can be configured to be hermetically closed to receive and hold the diluent under pressure and to retain the infusable food ingredient. The infusable food ingredient can be roast and ground coffee, tea leaves, herbs, botanicals, as well as other substances.

The machines of the set can comprise one food ingredient storing module said storing module comprising one device for storing the food ingredient and said storing module being selected in a plurality of different alternative modules for storing the food ingredient, said different alternative modules differing by the types of containers configured for storing the food ingredient and/or by the number of the containers configured for storing the food ingredient. The types of containers can be selected in the list of disposable containers and non disposable containers. The disposable containers are usually containers that are temporally placed in the machine until they are empty. The disposable container can also be a disposable cup in which one dose of food ingredient has been previously enclosed; this container is also known as opercule cup. The non disposable containers are usually tanks of the machines that can be temporally removed from the machine for refilling. The types of containers can also be selected in the list of multi-dose containers and single dose containers (like capsules, pods).

The machines of the set can comprise one food ingredient dosing module said dosing module comprising one device for dosing the food ingredient and said dosing module being selected in a plurality of different alternative modules for dosing the food ingredient, the different alternative modules differing by the devices for dosing the food ingredient. The different devices for dosing do not simply differ by the weight or volume for a dosing but by the concept of dosing. The devices for dosing can be comprised in the list of a dosing screw, a dosing auger, perforated discs, peristaltic pumps. The machines can also differ by the absence or the presence of a food ingredient dosing module.

If the machines of a set requires motors for actuating the different devices in the modules, all the motors are preferably placed in the same module. For example the food ingredient processing module can hold the motors for the whipper bowl and for actuating the dosing device. This implementation enables the reduction of the number of parts of the dispenser.

The machines of the set can also comprise one interface module, said interface module being selected in a plurality of different alternative interface modules. The alternative interface modules can differ by their nature like touch screen, buttons and/or by their number of buttons, by the presence of a display screen. They can also differ by the presence of customer identification devices (RFID cards, ID cards, camera, finger print recognition . . . ) or different payment interfaces.

The machines of a set preferably comprise common frame elements.

According to a first preferred embodiment, the core unit and at least one of the processing, storing or dosing modules comprise their own frame. Then the core unit and at least one of the modules can be pre-assembled separately in their own frame before being further assembled together. Preferably, according to this embodiment, each of the core unit and of the processing module comprises their own frames and the storing and/or dosing modules are placed in the processing module frame. According to one variant, the set of machines can comprise machines of different sizes, and then the machines of the set can comprise core units and sub-units modules differing by their sizes too. The choice of the size of the frame usually depends from the size of the storing module, which usually depends from the number of different food ingredients that can be stored.

According to a second embodiment, the machines comprise one core frame in which the core unit and each of the processing, storing and dosing modules are fixed. According to one variant, the set of machines can comprise machines of different sizes, and then the machines of the set can comprise a frame selected in several frames differing only by their sizes. The choice of the size of the frame usually depends from the size of the storing module, which usually depends from the number of different food ingredients that can be stored.

Generally the frames are made at least of left, right and bottom panels. Whether defined for the whole machine or simply for the core unit or for one module, the frame panels are preferably configured for being able to create different sizes of machines. According to one embodiment the machines preferably comprise some frame panels common to all the machines. These common panels are preferably left and right side panels of the core unit and the modules. When assembled these right and left panels determines the size of the smallest machine of the set of machines. The size of the core unit and the modules can be increased with a central panel that is intermediary attached to the right and left panels. The panels usually presents connection elements so as to be attached together in a simple and rapid manner, preferably these connection elements are clipping elements. Preferably the frame panels present openings for enabling the electric or fluid connections of the different elements of the machine. These openings are preferably placed in the panels at the back of the core unit.

Preferably in the set of machines according to the present invention in each machine the different components are placed according to the following order from the bottom up to the top: the core unit under the processing module under the dosing module under the packaging module.

According to a second aspect, the invention concerns a process for configuring a beverage production machine from a set of differing beverage production machines such as described hereabove comprising the steps of:

selecting the food processing module, then

selecting the storing module, then

selecting the user interface.

The dosing module is preferably selected based on the selection of the storing module. Actually if during the selection of the storing module, a single dose containers (like capsules, pods) or an opercule cup is selected, then no dosing module is required for the machine. The modules can also be selected according to the desired quality of beverages delivered by the machine. For example a whipper bowl usually dispenses a better quality beverage than a diluent jet head.

According to a preferred embodiment the configuration can be made through an internet interface.

According to a third aspect, the invention concerns a process for manufacturing a beverage production machine from a set of differing beverage production machines such as described hereabove comprising the steps of:

pre-assembling:
a core unit at least configured for supplying a diluent, and
sub-units modules for storing the food ingredient and/or sub-units modules for dosing the food ingredient and/or sub-units modules for processing the food ingredient,

configuring the machine by selecting the food ingredient storing module and/or the food ingredient processing module and/or the food ingredient dosing module,

assembling the pre-assembled core unit and the selected pre-assembled modules necessary for the configured machine.

The configuring step can also comprise the selection of the number of food ingredient storing modules, the number of food ingredient processing modules and the number of food ingredient dosing modules.

The pre-assembled core unit and the selected pre-assembled modules are preferably assembled together by sliding in and/or stacking on. Preferably the core unit constitutes a base on which the sub-unit modules are assembled.

Generally during the assembling step the selected pre-assembled modules are placed above the core unit elements according to the following order: the processing module then the dosing module and then the storing module.

According to the a first embodiment,

during the pre-assembling step a frame is preassembled,

during the assembling step the core unit is placed in the frame and then the sub-units modules are assembled together by sliding in the frame and/or stacking in the frame or on the core unit or on another sub-unit module. According to this embodiment, it is possible to pre-assemble frames of different sizes so as to assemble inside bigger sub-unit modules, in particular a bigger storing module able to store several different beverages ingredients.

According to the a second preferred embodiment,

during the pre-assembling step the core unit and at least one of the sub-units are pre-assembled in separate frames,

during the assembling step the core unit and the sub-units modules presenting pre-assembled own frames are assembled together.

Subsequently the sub-units modules that do not present pre-assembled own frames can be placed in the sub-units modules presenting pre-assembled frame.

### BRIEF DESCRIPTION OF THE DRAWINGS

The characteristics and advantages of the invention will be better understood in relation to:

FIGS. 1a and 1b depict a set of three differing beverage production machines according to the present invention,

FIG. 2 illustrates an opercule cup,

FIG. 3 depicts another set of two differing beverage production machines according to the present invention.

### DETAILED DESCRIPTION OF THE DRAWINGS

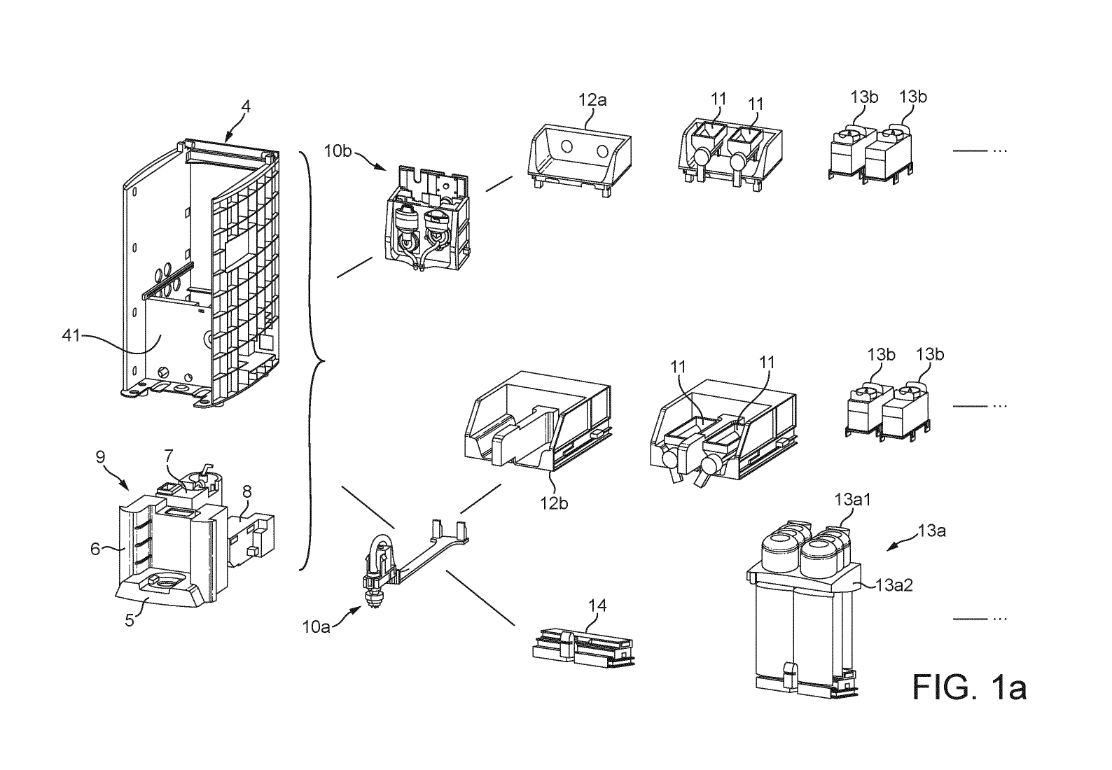

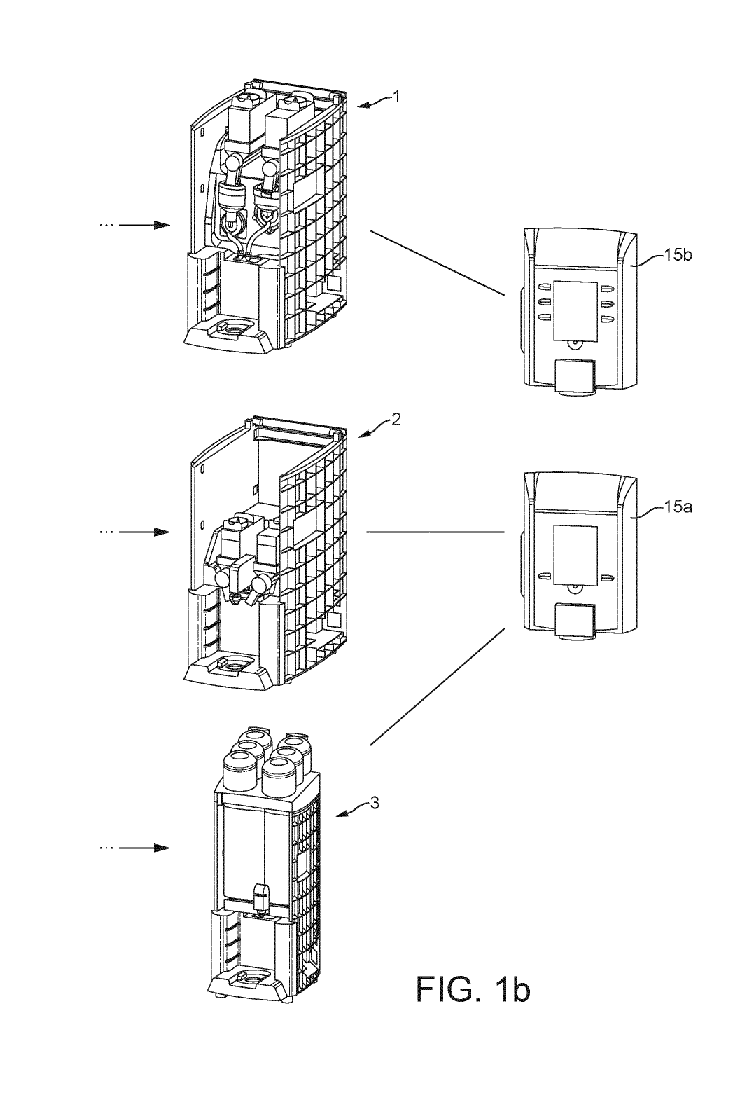

FIGS. 1a and 1b illustrate a set of three differing beverage production machines 1, 2, 3. The three machines presents the same frame 4 comprising two laterals walls, a back wall, a bottom plate and an inside compartmenting wall 41. The three machines also present the same core unit 9 consisting of a dispensing area 5, a water tank 6, a boiler 7 and an electronic control unit 8. These elements of the core unit 9 can be placed at the bottom of the frame 4 according to their relative position in FIG. 1a: the dispensing area 5 and the water tank 6 are positioned in front of the compartmenting wall 41 of the frame and the boiler 7 and the electronic control unit 8 are positioned behind the compartmenting wall 41 of the frame. Holes in the lateral and back walls of the frame 4 enable the electric connection of the electronic control unit 8 with the other elements of the dispenser and the fluid connection of the boiler 7 with the other elements of the dispenser.

Starting from the frame 4 and the core unit 9 different food ingredient processing modules 10a, 10b can be selected to build a beverage preparation machine. The food ingredient processing module can be either a head for delivering water jet(s) 10a or two whipping bowls 10b. The module of the jet(s) head for delivering water jet(s) 10a is configured so that it can be stacked on the core unit 9. The module of the two whipping bowls 10b is configured so that it can slide in the frame 4 above the core unit 9. The module 10a is configured so that the jet(s) of water of the module 10a reach the dispensing area in which a cup is usually placed. The module 10b is configured so that the outlets of the whipping bowls deliver the beverage in the dispensing area.

Further to the food ingredient processing modules option, the machines can comprise or not a food ingredient dosing module 11. The food ingredient dosing module of two machines 1, 2 comprises two dosing screws hold at the bottom of a powder receiver. The module can comprise a support plate 12a, 12b, to hold the dosing device above the food ingredient processing module 10a, 10b. The support plate can be configured for sliding in the frame 4 or being stacked above the food ingredient processing module 10a, 10b.

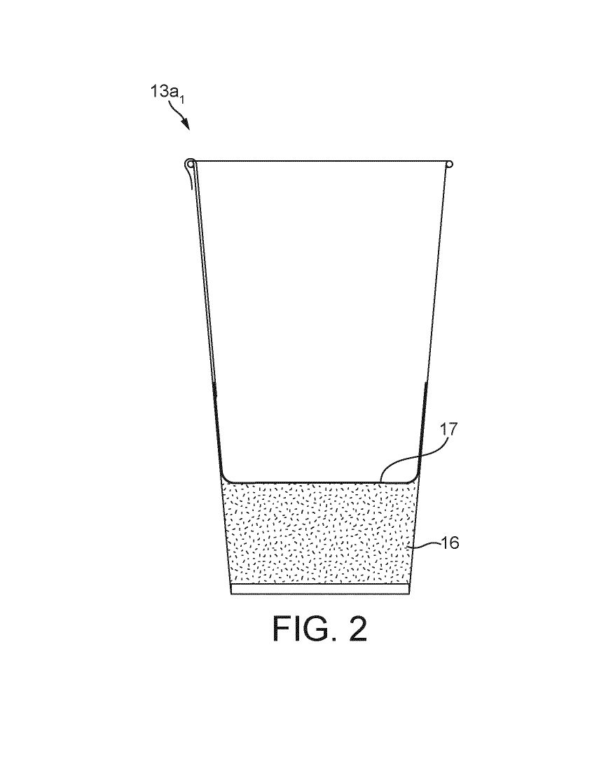

Further to the food ingredient processing and dosing modules options, different food ingredient storing modules 13a, 13b can be selected to build the beverage preparation machines. The food ingredient storing module can be either a non disposable container 13b or disposable cups 13a₁ with a food ingredient dose stored inside (more explicitly described in FIG. 2) stacked in cups holder assembly 13a₂. The module 13a comprises a support plate 14 to hold the storing device above the food ingredient processing module 10a. The support plate can be configured for either sliding in the frame 4 or being stacked above the food ingredient processing module 10a. In the case of the implementation of the module 13b the non disposable container can be simply clipped on the dosing module 11.

By the selection of the processing module of the head for delivering water jet(s) 10a and the storing module of the disposable cups 13a associated to the sliding support 14 the machine 3 can be conceived on which a front panel 15a comprising a display screen and two selection buttons is placed. This machine enables the production of varied beverages, the nature of which depending from the food ingredient stored in the disposable cup, with hot or cold water selected by the two buttons choice.

By the selection of the processing module of the head for delivering water jet(s) 10a, the dosing module 11 and the storing module comprising two non disposable containers 13b associated to the sliding support 12b, the machine 2 illustrated in FIG. 1b can be conceived. It can be finalised by adding a front panel 15a comprising a display screen and two selection buttons. This machine enables the production of two beverages based on the food ingredient stored in the containers and selected by the two buttons choice.

By the selection of the processing module with 2 mixing bowls 10b, the dosing module 11 and the storing module comprising two non disposable containers 13b associated to the stacking support 12a the machine 1 illustrated in FIG. 1b can be conceived. It can be finalised by adding a front panel 15b comprising a display screen and six selection buttons. This machine enables the production of six beverages based on the food ingredient stored in the container, on the importance of the whipping in the mixing bowls and on the mixture of the whipped beverages in the final cup. For example based on a coffee soluble powder and milk soluble powder stored in the containers 13b, the machine 1 can deliver a black coffee, an espresso coffee, a white coffee, a cappuccino, a ristretto and a cup of milk.

All the machines 1, 2, 3 of the set can be finalised with decorative panels connected on the frame panels and eventually on the top.

FIG. 2 illustrates an opercule cup 13a that can be part of a storing module 13a: the cup comprises a single dose of soluble food ingredient 16 at the bottom of the cup. The cup also comprises an opercule 17 that is detachably sealed to the internal surface of the cup and that packs that food ingredient in the bottom portion of the cup. Before preparing a beverage the consumer removes the opercule 17 and then introduces water in the cup for example by placing the cup in the dispensing area 5 of the machine 3. The opercule cup can be the cup described in WO 2008/003570.

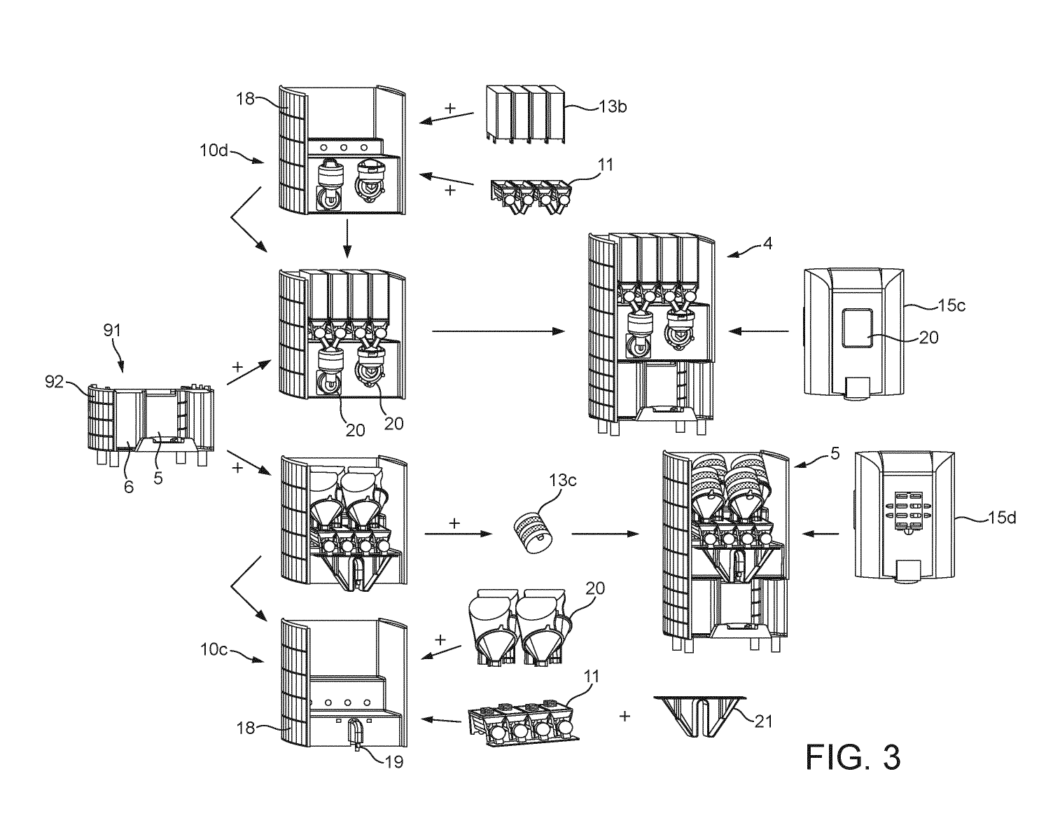

FIG. 3 illustrates a set of two differing beverage production machines 4, 5. The two machines present the same core unit 91 comprising an own frame 92 composed of two laterals walls and a bottom plate supported by four feet. The core unit 91 comprises also a dispensing area 5, a water tank 6, a boiler and an electronic control unit (not illustrated in FIG. 2). These elements can be placed in the core unit according to the same arrangement as in the core unit of FIG. 1 that is: the dispensing area and the water tank are positioned in front of the unit and the boiler and the electronic control unit are positioned backward.

Starting from the core unit 91 different food ingredient processing modules 10c, 10d can be selected to build a beverage preparation machine. The food ingredient processing module can be either a head for delivering water jet(s) 19 in the module 10c or two whipping bowls in the module 10d. In both cases the food ingredient processing module 10c, 10d has its own frame 18 in which the processing technology is assembled. Consequently these modules can be stacked on, or slid in, the core unit frame 92.

The module 10d is configured so that the outlets of the whipping bowls can be plugged with tubes delivering the whipped beverage in the dispensing area 5. The frame 18 of the module 10d is preferably conceived so as to be able to receive the dosing module and the storing module which are respectively in the illustrated embodiment 4: dosing screws 11 and 4 non disposable containers 13b. The dosing module 11 and the storing module 13b can be pre-assembled in the frame 18 of the food ingredient processing module 10d before said module is assembled on the core unit 91.

The module 10c is configured so that the jet(s) of water 19 of the module reach the dispensing area 5 in which a cup is usually placed. The frame 18 of the module 10c is preferably conceived so as to be able to receive the dosing module 11 and the storing module which are respectively in the illustrated embodiment four dosing screws and four places 20 for receiving fours, in particular tins 13c, two disposable containers being in front and the two others being behind. The dosing module also comprises devices for guiding the powder from the dosing screws to the dispensing area 5. The dosing module and the storing module can be pre-assembled in the frame of the food ingredient processing module 10c before said module is assembled on the core unit 91.

Finally a front panel can be assembled on the core unit and the food ingredient processing module. Machine 5 is manufactured with a front panel 15d comprising 4 selection buttons corresponding to the 4 ingredients storable in tins 13c. Machine 4 is manufactured with a front panel 15c incorporating a touch screen 20. Due to the presence of two whipping bowls, each of which being fed with two different ingredients stored in the non disposable canisters 13b, beverages issued from the combination of different ingredients can be prepared like e.g. a cappuccino issued from the mixing of a full fat milk stored in a canister and prepared by a whipper specific for frothed milk and of a coffee stored in another canister and prepared by a whipper specific for coffee. The touch screen of machine 3 avoids the presence of numerous buttons and gives a more rich-looking appearance.

The machines 4, 5 can be finalised with a back panel presenting holes to enable the electric connection of the electronic control unit with the other elements of the dispenser and the fluid connection of the boiler with the other elements of the dispenser.

The present invention presents the advantage of enabling the production of a very large set of machines that could differ by the process for handling the food ingredient and/or the manner of storing the food ingredient and/or the way to dose the food ingredient by using core units and variable alternative modules that can simply be assembled one to the others.

Another advantage of the building the dispensers in modules is the possibility to separately test each specific pre-assembled module before it is assembled in the dispenser improving manufacturing reliability and saving time for de-assembling in case of problem.

Another advantage of the present invention is that it enables the optimised production of different machines based on the same common elements but developed for different customers and channel needs. As an example in a set of machines according to the invention up to 40% of the elements of the machines can consist in common elements.

1-29. (canceled)

30. Set of differing beverage production machines, the machines comprising:
one core unit comprising at least a diluent supply system, the diluent supply system comprising at least a heating device, a pumping device and a valve device,
one food ingredient storing module, the storing module being selected in a plurality of different alternative modules for storing the food ingredient, the different alternative modules differing by the types of containers configured for storing the food ingredient and/or by the number of the containers configured for storing the food ingredient,
one food ingredient dosing module, the dosing module being selected in a plurality of different alternative modules for dosing the food ingredient, the different alternative modules differing by the devices for dosing the food ingredient and being selected from the group consisting of a dosing screw, and a dosing auger, and
one food ingredient processing module, the processing module being selected in a plurality of different alternative modules for processing the food ingredient, the different alternative modules differing by the devices for contacting the food ingredient with the diluent and the devices for contacting the food ingredient with the diluent being selected from the group consisting of: a jet(s) head, a mixing bowl, a whipper bowl, and a brewing chamber.

31. Set of differing beverage production machines according to claim 30, wherein all the motors for actuating devices in the modules are placed in the same module.

32. Set of differing beverage production machines according to claim 30, wherein the machines differ by the absence or the presence of a food ingredient dosing step module.

33. Set of differing beverage production machines according to claim 30, wherein the core unit and at least one of the processing, storing or dosing modules comprise their own frame.

34. Set of differing beverage production machines according to claim 30, wherein each of the core unit and of the processing module comprise their own frame and the storing and/or dosing modules are placed in the processing module frame.

35. Set of differing beverage production machines according to claim 30, wherein the machines comprise a core frame in which the core unit and each of the processing, storing and dosing modules are fixed.

36. Set of differing beverage production machines according to claim 30, wherein in each machine the different components are placed according to the following order from the bottom up to the top: the core unit under the processing module under the dosing module under the packaging module.

37. Process for configuring a beverage production machine from a set of differing beverage production machines comprising:
providing machines comprising one core unit comprising at least a diluent supply system, the diluent supply system comprising at least a heating device, a pumping device and a valve device, one food ingredient storing module, the storing module being selected in a plurality of different alternative modules for storing the food ingredient, the different alternative modules differing by the types of containers configured for storing the food ingredient and/or by the number of the containers configured for storing the food ingredient, one food ingredient dosing module, the dosing module being selected in a plurality of different alternative modules for dosing the food ingredient, the different alternative modules differing by the devices for dosing the food ingredient and being selected from the group consisting of a dosing screw, and a dosing auger, and one food ingredient processing module, the processing module being selected in a plurality of different alternative modules for processing the food ingredient, the different alternative modules differing by the devices for contacting the food ingredient with the diluent and the devices for contacting the food ingredient with the diluent being selected from the group consisting of: a jet(s) head, a mixing bowl, a whipper bowl, and a brewing chamber;
selecting the food processing module;
selecting the storing module; and
selecting a user interface.

38. Process according to claim 30, wherein the dosing module is selected based on the selection of the storing module.

39. Process according to claim 37, wherein the modules are selected according to the desired quality of beverages delivered by the machine.

40. Process according to claim 37, wherein the configuration is made through an internet interface.

41. Process for manufacturing a beverage production machine from a set of differing beverage production machines comprising:
providing machines comprising one core unit comprising at least a diluent supply system, the diluent supply system comprising at least a heating device, a pumping device and a valve device, one food ingredient storing module, the storing module being selected in a plurality of different alternative modules for storing the food ingredient, the different alternative modules differing by the types of containers configured for storing the food ingredient and/or by the number of the containers configured for storing the food ingredient, one food ingredient dosing module, the dosing module being selected in a plurality of different alternative modules for dosing the food ingredient, the different alternative modules differing by the devices for dosing the food ingredient and being selected from the group consisting of a dosing screw, and a dosing auger, and one food ingredient processing module, the processing module being selected in a plurality of different alternative modules for processing the food ingredient, the different alternative modules differing by the devices for contacting the food ingredient with the diluent and the devices for contacting the food ingredient with the diluent being selected from the group consisting of: a jet(s) head, a mixing bowl, and a whipper bowl;
pre-assembling the machine:
the core unit at least configured for supplying a diluent,
sub-units modules for storing the food ingredient and/or sub-units modules for dosing the food ingredient and/or sub-units modules for processing the food ingredient,
configuring the machine by selecting the food ingredient storing module and/or the food ingredient processing module and/or the food ingredient dosing module, and
assembling the pre-assembled core unit and the selected pre-assembled modules necessary for the configured machine.

42. Process according to claim 41, wherein the configuring step also comprises the selection of the number of food ingredient storing modules, the number of food ingredient processing modules and the number of food ingredient dosing modules.

43. Process according to claim 41, wherein during the assembling step the selected pre-assembled modules are placed above the core unit elements according to the following order: the processing module then the dosing module and then the storing module.

44. Process according to claim 41, wherein:
during the pre-assembling step a frame is pre-assembled, and
during the assembling step the core unit is placed in the frame and then the sub-units modules are assembled together by sliding in the frame and/or stacking in the frame or on the core unit or on another sub-unit module.

45. Process according to claim 41, wherein:
during the pre-assembling step the core unit and at least one of the sub-units are pre-assembled in separate frames, and
during the assembling step the core unit and the sub-units modules presenting pre-assembled own frames are assembled together.

46. Process according to claim 41, wherein during the assembling step the sub-units modules that do not present pre-assembled own frames are placed in the sub-units modules presenting pre-assembled frame.
